(19) United States
(12) Patent Application Publication
(10) Pub. No.: US 2026/0145075 A1
(43) Pub. Date: May 28, 2026

(54) MODIFYING EXTERNAL MUSIC OF A PLAYER TO CORRESPOND WITH ORIGINAL SCORE OF VIDEO GAME

(71) Applicant: Sony Interactive Entertainment Inc., Tokyo (JP)

(72) Inventor: Victoria Dorn, San Mateo, CA (US)

(21) Appl. No.: 18/962,824

(22) Filed: Nov. 27, 2024

(51) Int. Cl. A63F 13/60; G11B 27/031

(52) U.S. Cl. CPC A63F 13/60; G11B 27/031

(57) ABSTRACT

Methods and systems for customizing a video game for a user includes synthesizing a background music selected for rendering during gameplay of a video game so as to mimic the mood of the video game and to match a music style for an activity occurring in the video game. The customizing includes detecting an activity occurring in the video game, identifying attributes that define a music style of the activity, identifying an audio clip for the activity from the background music, and dynamically adjusting a portion of the background music that corresponds with the activity so that the audio content from the identified audio clip that substantially mimics the mood of the original game music for the activity, is rendered in place of original content of the original game music, during gameplay of the video game.

### 1. FIELD OF THE INVENTION

The present disclosure relates to providing option to a user to replace original game music with background music selected by the user, and more specifically, to transform the selected background music to match a music style included in the original game music when rendered during gameplay of the video game.

### 2. DESCRIPTION OF THE RELATED ART

### Background of the Invention

Video gaming industry has grown in popularity and represents a large percentage of the entertainment market and interactive content generated worldwide. Various types of video games are available for playing, including single-player video games and multi-player video games. In the case of multi-player video games, the users can play independently against one another or can be part of a team of users playing against at least one other second team. The users of the multi-player video games can be co-located or remotely located from one another. A player selects a video game for gameplay and provides game inputs. The game inputs are used to affect a game state of the video game and to update game content. In the case of the multi-player video game, the game inputs of the different players are used to affect the game state and to synchronize the game content generated and returned to the client devices associated with the different players. The updated game content includes game scenes generated to represent current game state of the video game.

To keep the user engaged and to allow the user to have a satisfactory gameplay experience, the video game is developed to include game music. The game music is designed to match to the intensity of the activities occurring in the video game to allow the player to immerse in the gameplay and experience the ebbs and flows of the video game. The game music enhances the gameplay experience of the player by allowing the player to be part of the storyline that is being weaved using the inputs provided by the user during the gameplay of the video game.

Although the game music is carefully designed to react to the inputs of the player (i.e., a user currently involved in gameplay) and to allow the user to feel the ebbs and flows of the game, oftentimes, the player would want to personalize their gameplay experience by listening to music of their own choice during gameplay of the video game. The video game developer has catered to the needs of the player by providing the player with options to select a music score (also referred to as ‘background music’) of their choice and switching the game music (also referred to as “original score” or “original game music”) with the selected background music. Although the player is provided This level of flexibility allows the player to continue to engage in gameplay of the video game while enjoying listening to music of their own choice. Switching the game music with the player's choice of background music, however, comes with a great disadvantage in that the background music does not follow the ebbs and flows of the gameplay (i.e., the intensity of the gameplay of the video game) of the player. As the background music is not tied to the game content, the background music may not synchronize with the intensity of the gameplay of the player (i.e., does not match the aesthetics of the game), causing the player to have a less than satisfactory gameplay experience.

It is in this context that embodiments of the invention arise.

### SUMMARY OF THE INVENTION

Implementations of the present disclosure relate to systems and methods for detecting selection of a background music by a user and switching a game music designed for a video game with the selected background music, so as to allow the user to enjoy their choice of background music during gameplay of the video game. The selected background music is dynamically adjusted to follow the ebbs and flows of the video game resulting from inputs (i.e., in-game actions) of the user received during gameplay. User inputs received during gameplay of the video game are used to update a game state of the video game and to generate appropriate game content for returning to client device(s) of the user(s). The user who selects a video game for gameplay is also alternately referred to as a “player”. The updated game state and the game content generated for the video game are used to determine context of gameplay and a game style of the video game during a current game time. The game style encompasses both a visual style of the game scene as well as music style of the game music. Based on the context, a portion of the background music selected by the user for rendering during gameplay, is dynamically adjusted to match the music style of the original music defined for the video game. The portion of the background music that is dynamically adjusted may correspond to an activity occurring the video game. The dynamic adjustment is done in substantial real-time as the user is playing the game, so that the adjusted portion of the background music matches or substantially mimics the music style of the original game music defined for the portion.

Game style (i.e., visual style and aural or audio presentation (i.e., music style)) of a video game, in many cases, is based on the gameplay mechanics (i.e., rules, game objects, processes that define how a game works and what defines a success or failure in the video game) defined in the game logic of the video game by the game developer. The game style is influenced by game scene design, storyline scripts defining the overall theme, the game music that is tied to the storyline scripts, overall aesthetics involved, etc., to create a unique experience for the user. The game style, in turn, impacts at least the perception of gameplay and emotional engagement of the user. The game music plays a significant role in influencing the user's perception and emotional engagement. Realizing the role of the game music, the game developer has provided options to customize the video game by allowing the user to switch the game music with the user selected background music. The background music of the user may be stored and retrieved from an audio source, such as an audio playlist, audio library in memory, etc., or may be selected from a social media application, an online music application, etc., which can be subscription-based or subscription-free.

In response to the user selecting the video game for gameplay and a background music for playing during the gameplay of the video game, the game music associated with the video game is switched with the selected background music, so that the background music is played in place of the original game music during the user's gameplay. In some implementations, the switching may be done by pausing or muting the game music designed for the video game and rendering the background music. In addition to switching, the selected background music is dynamically tuned or modified to reflect the game style of the video game. The dynamic tuning can be done for a portion of the background music. The portion of the background music for dynamic tuning may be associated with an activity occurring in the video game, wherein the activity is identified by examining the current game state and game content. The dynamic tuning is done by identifying attributes of the background music currently rendering in a portion of the video game where the activity is occurring, the game state and game content of current gameplay of the video game, a current context of the gameplay (determined by analyzing the game state and the game content), details of the activity occurring in the video game, and attributes of the original game music defined for the activity related to the current context. The tuning is done to one or more attributes (e.g., volume, pace, intensity, mood, pitch and rhythm (collectively termed ‘melody’), etc.) of the background music in the portion related to the activity. In alternate implementations, a portion of the background music corresponding to the current game context is modified by replacing the portion of the background music with another portion identified from within the background music, wherein the other portion is identified to match to the game style defined for the activity. Alternatively, the portion of the background music can be replaced with a portion extracted from a second background music or a portion of the original game music, wherein the portion from the second background music or the original game music is identified to match the game style of the activity identified in the video game. The adjusted background music is rendered in relation to the activity (i.e., in the beginning, during or upon conclusion of the activity), wherein the time for rendering depends on the type of activity. The various implementations allow the user to customize their gameplay to have an emotional engagement and a satisfactory gameplay experience.

In one implementation, a method is disclosed. The method includes, analyzing an original music defined for a video game selected by a user for gameplay. The video game is defined to include a plurality of activities. The analysis of the original music is to identify attributes defining a music style corresponding to each activity of the plurality of activities identified in the video game. Each background music associated with the user is analyzed to identify a portion in each background music with attributes that match the music style of each activity of the plurality of activities identified in the original music. User selection of the video game for gameplay and a background music for rendering during gameplay is detected. The selected background music is rendered in original format during gameplay of the video game. When an activity is detected during gameplay, the original format of a portion of the background music corresponding to the activity is dynamically adjusted so that a portion of the background music identified to mimic the music style of the activity is rendered instead. The corresponding portion of the background music is identified using attributes of the activity. The adjusted background music matches a context of the video game.

In another implementation, a method is disclosed. The method includes analyzing an original game music associated with a video game selected by a user for gameplay to identify attributes of each activity included therein. The identified attributes define a music style corresponding to said each activity. A background music selected by the user for rendering during gameplay of the video game is analyzed to identify each portion of the background music having attributes that match to a music style defined for each activity. Each portion of the background music for each activity is identified by matching original attributes defining the music style of each activity in the original music with the attributes of each corresponding portion of the background music. A new background music is generated by mixing the background music with the original music, such that each portion of the background music identified for each activity replaces original content of a corresponding portion of the original game music. The generated new background music matches aesthetics of each activity of the original game music defined for the video game.

In yet another implementation, a method is disclosed. The method includes analyzing gameplay data of a video game to identify each activity and attributes of said each activity occurring during gameplay of the video game. The gameplay data generated during gameplay is analyzed to determine game context and to identify each activity occurring during gameplay. The video game is rendering using original content of an original game music. A resumption point associated with an activity occurring during gameplay is identified. A select background music having a portion of audio with attributes that match with a music style of the activity is identified and a portion of the original game music starting at the resumption point is transitioned to render the portion of the audio of the select background music and the original content of the original game music is resumed after completion of the portion of the audio of the select background music.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a cloud system that is used to render background music selected by a user during gameplay of a video game and to tune or modify the background music so as to match a music style defined in the original music, in accordance with one implementation.

FIG. 2 represents a simplified block diagram of an audio synthesizer engine engaged to identify a background music selected by a user for rendering during gameplay and to adjust the background music to match music style for each activity occurring in the video game, in accordance with one implementation.

FIG. 3A illustrates a timeline of a game score or background music interleaved with clips from within the background music identified for rendering during different activities occurring in the video game, in accordance with one implementation.

FIG. 3B illustrates a timeline of a game score or background music interleaved with clips from different background music identified for rendering during different activities occurring in the video game, in accordance with an alternate implementation.

FIG. 4 illustrates a timeline of an original game score generated for the video game, a timeline of a background music selected from an audio source of a user for rendering during game play, and a new game music track generated by interleaving portions of the original game score with portions of the selected background music that match the music style of different activities, in one implementation.

FIG. 5 illustrates components of an example system that can be used to process audio signals generated for the user during gameplay of a video game, in accordance with one implementation.

### DETAILED DESCRIPTION

Broadly speaking, implementations of the present disclosure relate to processing a request from a user selecting a video game for gameplay and a background music for rendering during gameplay of the selected video game. Responsive to the request, the game music defined for the video game is switched with the background music selected by the user. The background music may be part of a playlist maintained for or by the user, or identified from a music application or a social media application or obtained by querying an external audio source, which receives audio content (e.g., background music) from an audio content generator or audio content distributor or an external audio library that the user is able to access. The audio source could be subscription-based or subscription-free. In some implementations, the background music may be identified from user preferences maintained in a user profile of the user or specified during selection of the video game.

Inputs provided by the user during gameplay are used to update a game state of the video game and to generate game content that is returned to a client device of a user providing the inputs. Inputs from the user, the game state and the game content for the current gameplay session are maintained as game data for the video game. The game state and game content are analyzed to determine game context and to determine when an activity is occurring in a current portion of the video game. In response to detecting an activity occurring in the current portion of the video game, the attributes of the activity are obtained by querying game data. The attributes include a type of activity that is occurring, a level of skill needed, game objects and/or participants involved, etc. The attributes of the activity are used to query the original game music defined for the video game to identify a music style defined for the activity. In some cases, the activity can be a distinct activity that occurs only once during gameplay (e.g., crossing a finish line, successfully completing all the challenges, etc.) or can be a recurring one (e.g., a “Boss” fight or encounter with an adversary or a challenge). In the case of a recurring activity, the activity can occur multiple times within a single game scene or can occur in multiple game scenes, wherein each occurrence can incrementally increase in difficulty.

The attributes related to the music style of the activity in the original music is matched with corresponding attributes from the background music and a portion of the background music with attributes that match the attributes of the original music is identified and used in place of original content of the background music so that the portion of the background music can be rendered during the activity. After completion of the activity, the original content of the background music is resumed. The portion of the background music rendered during the activity matches the aesthetics of the activity and mimics the music style of the original music, allowing the user to emotionally connect and have a fully immersive experience during the gameplay of the video game with the music of their choice.

With the general understanding of the disclosure, specific implementations of the disclosure will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

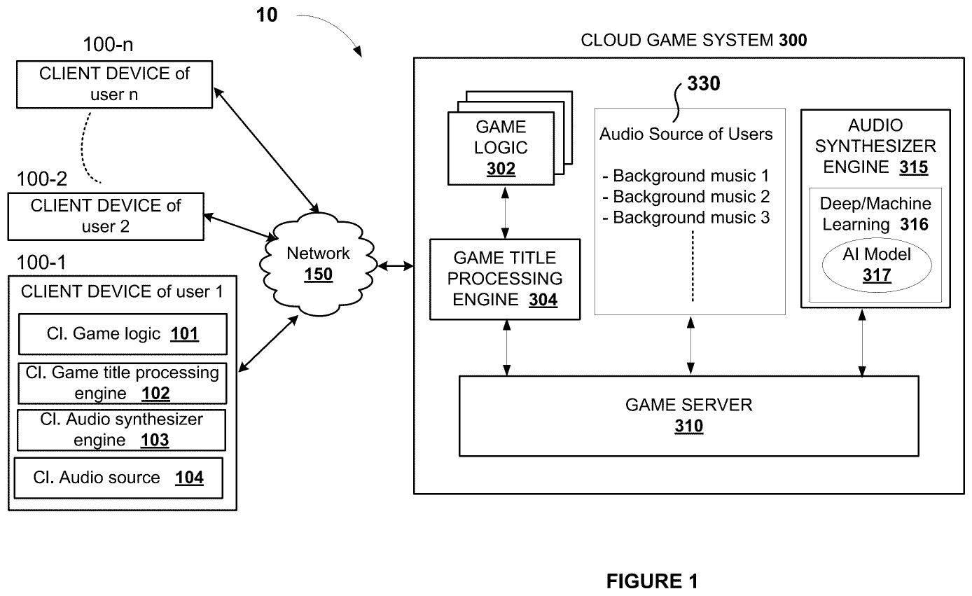

FIG. 1 illustrates a system 10 configured for presenting options to a user for selecting a background music for rendering in place of original game music during gameplay of a video game and to modify or tune the background music so as to match the music style defined in the original music, in accordance with one implementation of the present disclosure. The background music is automatically selected, based on a music preference of the user selecting the video game for gameplay or is explicitly selected by a user. In the case where the user selects the background music for rendering with the video game, options may be provided on a user interface for user selection, wherein the options may identify a list of background music identified from a playlist maintained in an audio library associated with the user or from an audio source, such as a music application, content provider or content distributor, social media application, social music application, etc. The audio source can be maintained locally at a client device of the user or in a remote storage, such as a cloud storage at or accessible to a cloud server, such as a cloud game system 300.

The system 10 is configured to provide gaming over a network 150 for one or more client devices 100 (e.g., 100-1, 100-2, . . . 100-n) associated with one or more users. In particular, system 10 may be configured to enable users to interact with interactive applications, including video games. The users can participate in the video game either in a single-player or multi-player mode via a cloud game system 300, wherein the game can be executed locally (e.g., on a local client device 100 of the user or at a local game console that is communicatively coupled to the client device 100 of the user) or can be executed remotely from a corresponding client device 100 (e.g., acting as a thin client or a regular client) of the user that is playing the video game, in accordance with one implementation. In one implementation, the cloud game system 300 supports a multi-player gaming session for a group of users, wherein the respective client devices 100 independently communicate the game inputs of the respective user of the group of users to the video game executing on the cloud game system 300 via network 150 and, in return, receive game content generated by applying the game inputs from the users. The game content returned to the client devices 100 are synchronized amongst the users so that all of the users are presented with current game state of the video game. In addition to communicating video game related data, the cloud game system 300 also manages communications between users in real-time via chat interface or other communication interfaces either rendered in a portion of a user interface that is used render the game content of the video game or in separate communication interface in real-time. In other implementations, the cloud game system 300 supports multiple users participating in a metaverse.

In some embodiments, the cloud game system 300 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session where a group of users are participating in a video game (or metaverse), an instance of the application may be executing locally on a client device (e.g., desktop computer, laptop computer, tablet, mobile device, head mounted display, etc.). In such cases, an instance of the video game is installed and executed on the client device 100. The client instance of the video game includes a client version of game logic 101, a client game title processing engine 102, a client audio synthesizer engine 103 and a client audio source 104 to allow the user to participate in the video game and provide game inputs via controls provided at the client device 100. The game inputs are communicated to the cloud game system 300, which coordinates the game inputs from the group of users, manages the game state and synchronizes game content returned to the client device of the respective users. In the case where the client device of a user is a thin-client that does not have the computational power to execute an instance of the video game locally or where an instance of the video game is not available, the client device is used to access a cloud-based instance of the video game executing at a game server 310 of the cloud game system 300.

In some cases, the cloud game system 300 is a collection of game servers and application servers including server blades, game consoles, etc., disposed in one or more data centers and networked together to allow communication amongst the different servers/consoles and between the different servers and the client devices 100. As shown, the cloud game system 300 includes a game server 310 that provides access to a plurality of video games identified using a respective game title and defined using a corresponding game logic 302. A game title processing engine 304 is configured to use a game title (i.e., game identifier) to identify each video game requested by one or more users. Applications (i.e., video games) played in a corresponding single player and/or multi-player session may be played over the network 150 with connection to the game server 310. For example, in a multi-player session, multiple instances of a video game (e.g., for generating game scenes of a virtual environment, game state of the gaming world, metaverse, etc.) are executed on one game server 310 or multiple game servers (310) located in a single data center within a cloud game system 300 or in multiple data centers distributes across different geo locations and communicatively networked with one another. The users may be executing local instances or cloud-based instances of the video game. In particular, the cloud game system 300 may manage a virtual machine supporting a game processor that instantiates a cloud-based instance of an application for a user. As such, a plurality of game processors of game system 300 associated with a plurality of virtual machines is configured to execute multiple instances of one or more video games associated with gameplays so that each instance of the video game is accessed by a plurality of users.

A dedicated server application (e.g., a session manager) may be used to collect data (i.e., input data) from users and forward to the game server(s) 310 to update game data generated for the video game. Game state and game content (e.g., objects, scenes, states, levels, etc.) generated from the updated game data are synchronized across all instances and distributed to all users to allow for real-time interaction within the virtual environment of the multi-player session. Game server 310 is configured to apply the input data collected from different users, update the game state, synchronize the game state across all instances (both local and cloud-based instances), generate the game data (e.g., game content including images/scenes of a corresponding gameplay), encode and stream the game data in frames of game content back to a corresponding client device 100 through network 150.

As noted above, in single-player or multi-player sessions, instances of an interactive application (e.g., a video game) may be executing locally on a client device 100 or at the cloud game system 300. In the case of local execution of the instance of the interactive application (i.e., video game), the game logic 101 associated with the interactive application is identified using a game title and executed by a game engine 102 (e.g., game title processing engine). In the case of cloud-based execution of an instance of the interactive application, the game server 310 is used to identify the game logic 302 of the video game (i.e., interactive application) using the game title and is instantiated by a game title processing engine 304. For purposes of clarity and brevity, the implementation of game logic 302 and game title processing engine 304 is described within the context of the cloud game system 300. However, the application may be executed by a distributed game title processing engine (alternately referenced herein as “game engine”). The game server 310 provides the necessary hardware and other resources and the game title processing engine 304 includes basic processor-based functions for executing the instances of the video game (i.e., interactive application) and services associated with the application. For example, processor-based functions include 2D or 3D rendering, physics, physics simulation, scripting, audio, animation, graphics processing, lighting, shading, rasterization, ray tracing, shadowing, culling, transformation, artificial intelligence, etc. The game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication channels, audio communication, texting, messaging, instant messaging, chat support, game play/replay functions, help functions, etc.

In one implementation, the cloud game system 300 supports artificial intelligence (AI) based services including chatbot services (e.g., ChatGPT, etc.) that provide for one or more features, such as conversational communications, composition of written material, composition of music, generating new music by combining clips from two or more music, answering questions, simulating a chat room, playing games, and others.

Users access the remote services with client devices 100, which include at least a CPU, a display and input/output (I/O). Alternately, the client devices 100 used for accessing the remote services on the cloud game system 300 can be thin clients. Thin clients have limited local resources for processing, data storage (i.e., memory), and operating system capabilities and rely on the server (e.g., cloud game system 300) for providing/accessing applications, processing resources, memory for data storage, etc. Accordingly, users may access cloud game system 300 via network 150 using corresponding client devices 100 configured for providing input control, updating a session controller (e.g., delivering and/or receiving user game state data), receiving and rendering streaming media, receiving selection of the video game and background music, etc. The background music may be selected for rendering during gameplay in place of an original game music defined for the video game (interactive application) and such selection of the background music may be made from an audio source 104 that is maintained locally at the client device 100 (in case of regular client device) or remotely at the cloud game system 300 (in case of thin client device). The regular client device 100 can be a personal computer (PC), a mobile phone, a personal digital assistant (PDA), handheld device, wearable device (e.g., head mounted display, smart watch, etc.) etc.

The client devices 100 may be operating using different platforms. For example, one or more client devices may be operating on a first platform (e.g., gaming consoles), and other client devices may be operating on a different platform (mobile phones or tablet computers). In still another example, a platform includes both a client device and game server 310 located at the cloud game system 300 and used to instantiate and/or access a cloud-based instance of an application. In one example, the different platforms can include different operating systems. Thus, each platform may include a combination of hardware and software components providing a set of capabilities in order to execute one or more software applications (e.g., video games).

In particular, client device 100 of a corresponding user is configured for requesting access to applications over a network 150, such as the Internet, and for rendering images and audio generated by or associated with a video game executed by the game server 310, wherein encoded images and the game related audio are delivered (i.e., streamed) to the client device 100 for display/rendering. For example, the user may be interacting with an instance of an application (e.g., video game) executing on a game processor of game server 310 using input commands provided through a client device 100 to drive a gameplay. Client device 100 may receive input from various types of input devices, such as game controllers, tablet computers, keyboards, touch screens, gestures captured by video cameras, mice, touch pads, audio input, etc.

Alternately, the user may be interacting with an instance of an application (e.g., video game) executing locally on a processor of the client device 100 and providing input commands to drive a gameplay using various types of input devices that are available locally or communicatively connected to the client device 100. As previously noted, the client device 100 may be equipped with a client game title processing engine 102 and client game logic 101 (e.g., executable code) with access to the applications stored locally, and is configured to retrieve and instantiate the game logic of the video game using the processing resources available locally. Data from the gameplay can be processed locally and transmitted over the network 150 to the cloud game system 300, in case of multi-game or cloud-based application, for further processing. The application executing at the cloud game system 300 synchronizes the game state at the server and across all the client devices 100. The streaming data generated by the application executing at the cloud game system 300 is streamed to the client device 100 for rendering and further interactivity. In addition to the game content, other content provided by back-end server is also streamed to the client device 100. In another implementation, client device 100 acts as a stand-alone system for purposes of executing the application, such as when supporting a game play of a single-player video game.

In addition, the cloud game system 300 includes an audio synthesizer engine 315 configured to synthesize a background music selected by the user for rendering in place of the original game music during gameplay of the video game, so as to match the music style of the game music and the overall aesthetics of the video game. The original game music may be an original music composed specifically for the video game or can be a music number that is licensed from an original composer and adjusted (i.e., tweaked) for the video game. In either case, the original game music is defined to match the intensity, pace, mood, speed, etc., of the video game so as to tie into the theme defined for different portions of the video game. In some implementations, the audio synthesizer engine 315 uses artificial intelligence in determining the music style of the game music and to mimic the music style of the original game music in the background music selected by the user for rendering during gameplay. In particular, the artificial intelligence can be used to identify each in-game activity that occurs during gameplay, determine the attributes of the activity, attributes of the game music defining the music style corresponding to the activity, game state and game context of the video game when the activity occurs during gameplay of the video game, and use the details to identify an audio clip from the background music that matches with the music style defined in the portion of the original game music that corresponds with the activity and the overall aesthetics of the video game. The artificial intelligence is then used to manipulate original content in the identified portion of the background music related to the activity, so that the adjusted audio clip is rendered in place of the original content of the background music for the activity. The background music with the adjusted audio clip rendered for the activity matches the aesthetics of the video game, thereby allowing the user to emotionally engage and have a satisfactory gameplay experience of the video game with the background music of their choice. It should be noted that the background music with the adjusted audio clip can be rendered in the beginning, at the end, or anywhere between the beginning and the end of the activity.

In some implementations, the audio clip for presenting during the activity is identified from within the selected background music. In alternate implementations, the audio clip matching the attributes of the portion of the original game music associated with the activity is identified from a second background music associated with the user. The second background music can be identified from an audio source and can be different from the original game music and the background music selected for rendering in place of the original game music. In yet another implementation, the audio clip for adjusting the background music can be identified and obtained from the original game music.

In some other cases, the user may wish to render the original game music during gameplay but alter a portion of the original game music related to an activity according to their specifications. In such cases, the user is allowed to specify one or more attributes of the original game music that they would like to alter in the portion and the type of alteration (e.g., enhance, diminish, mute, etc.) that they would like to experience. The artificial intelligence may be used to identify the portion and the current attributes associated with the portion of the original game music so that the one or more attributes of the portion can be adjusted in accordance to the user's specification prior to rendering for the user during the activity. For example, the user may specify that they would like the portion of the original game music (also referred to as “original audio track”) to only adjust the beats (i.e., a game music attribute) without adjusting any other attribute, and the artificial intelligence may adjust the beats in the portion of the game music accordingly by increasing or decreasing the beats per second, for example, (i.e., stretch or shrink in time) without adjusting or compromising other attributes (e.g., the pitch (e.g., frequency), mood, etc.) in the music, in some implementations.

The audio synthesizer engine 315 may be implemented at the back-end cloud game network, or as a middle layer third party service that is remote from the client device. In some implementations, the audio synthesizer engine 315 may be located at a client device 100. That is, the audio synthesizer engine 315 may be local to a user, such as operating within a client device 100 of the user, or may be remote from the user and operate at a back-end server (e.g., game server 310 or any other server within the cloud game system 300 accessed using the network 150.

The audio synthesizer engine 315, for purpose of synthesizing original game music and/or background music, engages artificial intelligence (AI) to identify and/or classify information related to a game play of a video game provided using the AI. For example, information related to the gameplay identified using the AI may include in-game related actions/activities (e.g., user based actions for controlling the gameplay, character and/or object based actions occurring within the gameplay, activities defined in the video game, etc.), attributes of the original game music rendered during each action/activity defining the music style, attributes of each action/activity (simply referred to as “activity”) occurring in the video game, game state and game context of the video game determined from game inputs provided by users during occurrence of each activity, timing related to each activity (e.g., time within gameplay when each activity occurs, frequency of occurrence, duration of activity, etc.). The audio synthesizer engine 315 obtains the game data generated during gameplay of the video game from the video game executing on the game server 310, the background music selected by the user from an audio source 330 associated with the user, analyzes and classifies the information using classifiers and the AI. The classified data is used by the AI to select, transform, tune and/or modify portions of the background music selected by the user for rendering for each activity occurring in the video game so that the selected, transformed or tuned background music substantially mimics the music style of the original game music and match the context of the video game. Alternately, the AI is used to transform, tune, and/or modify portions of the original game music so that the AI adjusted original game music matches the music style that the user desires.

In some implementations, in addition to analyzing the information from current gameplay of the video game by the user, the AI model 317 is used to analyze game state data of a plurality of gameplays of the video game as well as state data related to other interactive applications selected for interaction by the user. The analysis of the plurality of gameplays provides insight into the skills possessed, the type of gameplay desired/played (e.g., aggressive, calculated, defensive, etc.), the type of inputs (i.e., in-game actions) provided, activities attempted, timing and other information related to the activities attempted, the game state data of the game play of the video game by the user, etc. The analysis of state data related to other interactive applications (including music applications) provide type of interactive application accessed, type and other details of interaction provided (e.g., type of communications selected, communication content provided, frequency of selection of video game, type of game inputs provided, preference of audio source (playlist, audio library, content provider or content distributor website, social media applications, etc.), music genre preference, soundtracks preference selected from audio source, and any other data useful in determining a type of video game played and type of music selected for rendering. The identification and/or classification of information obtained from analyzing the information from current and prior gameplays, and interactions with other interactive applications may be performed using artificial intelligence (AI) via an AI model 317 that is generated and trained by a deep/machine learning engine 316 of the audio synthesizer engine 315.

In addition to obtaining and analyzing gameplay information of the user, gameplay information of the video game and of other interactive applications played/interacted by other users may also be gathered and analyzed to determine the preferences of the video game and /r interactive applications of other users, preference of the music for rendering during interaction with the video game and/or other interactive applications, etc. The information related to the interaction of the other users with the video game and other interactive applications may be used to further train the AI model 317 or may be used to generate individual AI models for each user. The information obtained from the different AI models 317 are gathered and intelligently used in predicting the user's own interactions and preferences. For example, if the user belongs to a particular demographic or particular group of users, then user's preferences in the selection and interaction with the video game and other interactive applications as well as the soundtrack may be influenced by the choice of other users.

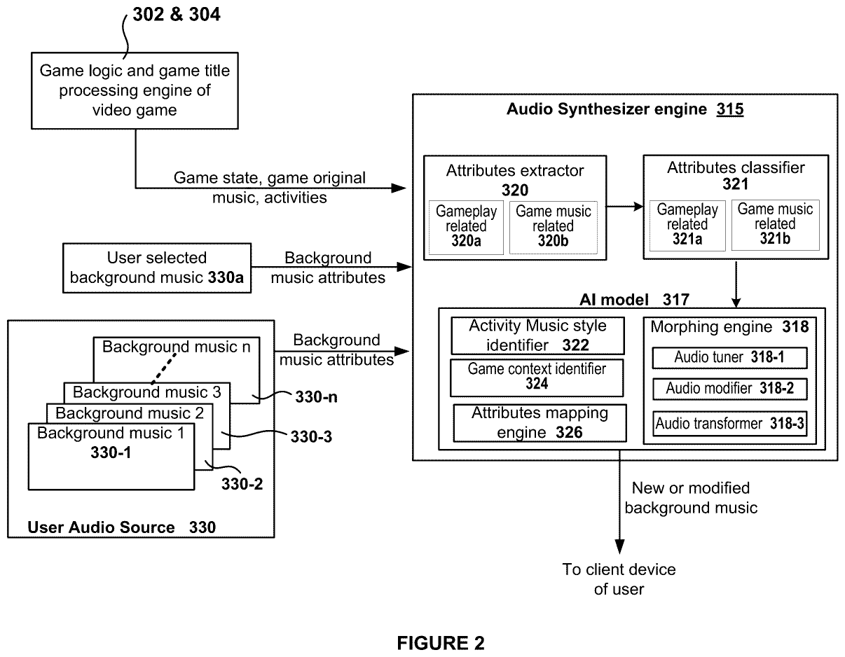

FIG. 2 illustrates components of an audio synthesizer engine 315 executing remotely on a server, such as a cloud server within a cloud game network and configured to synthesize the audio of a background music selected by the user for rendering during gameplay of the video game, in one implementation. In alternate implementations, the audio synthesizer engine 315 can be executing locally on a client device or a console communicatively coupled to the client device 100, or a first portion (i.e., client portion) of the audio synthesizer engine 315 can be executing locally on the client device 100 and a second portion (i.e., server portion) can be executing on the remote server. In the latter case, the first portion is communicatively connected to the second portion via network 150. The background music can be synthesized using AI, wherein the synthesis includes selecting, transforming, tuning and/or modifying so that the resulting synthesized background music matches the intensity of and context of the gameplay, allowing the user to have a personalized and impactful gameplay experience. The various functions for personalizing the music of the video game for the user may be implemented using the system components defined with reference to FIG. 1, including the audio synthesizer engine 315. Details of the various components of the audio synthesizer engine 315 will now be described with reference to FIG. 2.

The audio synthesizer engine 315 is configured to implement an AI model 317 for detecting, selecting, extracting, and classifying relevant information generated during gameplay of the video game, and to synthesize a background music selected by the user so as to match the music styles defined for the different activities and the aesthetics of the video game, in accordance with on implementation. As noted before, the audio synthesizer engine 315 of FIG. 2 can be implemented by the cloud game system 300 or the client device 100, or a combination thereof.

In some implementations, the audio synthesizer engine 315 may be executed during live gameplay of a video game and the AI model 317 may be trained, in part, to collect various data in substantial real-time from the live gameplay, identify in-game activities occurring during the live gameplay of the video game, and classify the in-game activities for purpose of understanding gameplay-related attributes and game music related attributes. The gameplay-related attributes that the AI model can classify and consider include type of gameplay being played, game context, type of activity encountered, speed and intensity of the gameplay from which speed and intensity of each activity encountered can be determined, type of inputs required and/or provided, type and tempo of original game music rendering during the activity, etc., to understand timing-related attributes of the encountered activity and the original game music. For instance, the type, intensity of the encountered activity, and the type and timing of inputs provided could provide an insight of when each type of activity occurs or can be predicted to occur, and timing cues related to the progress in gameplay (e.g., when the activity is starting, how the activity is progressing, type of ending encountered (successful, unsuccessful, paused, etc.)). Such attributes along with game context of the video game can be used by the audio synthesizer engine 315 with the aid of the trained AI model 317 to understand the music style of the game music accompanying each activity for different outcomes of the activity. Based on such understanding, the background music may be selected, adjusted, tuned, and/or modified to mimic the style of the original music and preserve the aesthetics of the video game.

The data (game state, game content, game context, game inputs, game music, etc.) from the gameplay of the video game are retrieved and provided to a deep/machine learning engine 316 to apply machine learning in order to generate and train an AI model 317 for synthesizing game music (either the original game music or the background music). The data can be retrieved or obtained from various data sources (e.g., cloud game server or the client device) by the audio synthesizer engine 315 through a communication network 150, or delivered directly. Similarly, data related to the background music selected for use during gameplay retrieved or obtained from an audio source (e.g., playlist, user generated music, music shared or obtained from social media platforms, music composer/distributor, etc.) associated with the user. The data collected from the different sources are extracted and classified, and the classified data is used by the AI model to determine game context pertaining to the activity, details of the activity and the original game music defined for the activity. In particular, the AI model uses the game state data, activity related attributes, game music attributes pertaining to the activity, for determining the game context and pace of the activity to determine intensity of gameplay.

The gameplay intensity can be driven by user-based actions (i.e., resulting from user inputs - magnitude, timing, frequency, rate of change of the user inputs, etc.) and game characters/game objects-based inputs (i.e., resulting from game characters or game objects reaction to the user-based actions, other users inputs (i.e., magnitude, timing, frequency, etc.) controlling the one or more game characters). The user-based actions and/or game characters-based actions can be used to determine the intensity of the gameplay and progress made in the video game.

The game state data defines the state of the gameplay of a video game currently executing for a user at any point in time. The game state data is used to generate the game scenario (i.e., game environment) at the corresponding time in the gameplay. The game state data may include state of the game characters, game objects, game scene, object and game character attributes, and other gameplay related data, in addition to the state of the various resources used for execution of the video game and a point in the video game related to the game state, wherein the point in the video game can correspond to a level, game scene, etc., where an action or activity is defined to occur and is obtained by querying the game logic. Additionally, the game state data can also provide information related to user personalization and user-related attributes, such as game characters preferred/selected to represent the user in the video game, user-specified personal attributes of the game character and personal settings for the video game, type of gameplay preferred, followed, game standing of the user (e.g., skills possessed, difficulty levels preferred or skilled, game levels achieved, game winnings, game lives, game objects/tools available, etc.), background music selected, etc.

The game state data is processed using an attributes extractor (a feature extractor) 320 to identify and extract relevant user-related, gameplay-related and game music-related attributes that are useful for determining the context of gameplay and information related to the original game music designed for rendering during different activities that is occurring. Similarly, data related to the background music selected by the user for customizing their gameplay of the video game, is processed to identify and extract the various attributes of the background music. The various attributes can be used to determine the different audio clips and type of each audio clip included within the background music, for example. An audio clip, as referred to herein, is defined as a section (i.e., or segment/portion) of the background music that is not a whole, and often corresponds with a particular activity or action defined within a game scene of the video game. The audio clip, in some implementations, can include one or more audio track elements, such as vocal track, instrumental track, sound effects, ambience, etc., wherein each element assists in creating an immersive experience by enhancing narrative, emotional connectivity, and enriched auditory environment for the user. In particular, these elements are used to establish rhythm, mood, tension, intensity, pace, etc. The audio clips can be identified based on type, duration, etc., and using parameters, such as tone, harmonics, quality, range of sound, sound tempo, melody, etc. The various extracted attributes (user-related, game-related, gameplay-related, music-related) are classified using an attribute classifier 321.

The classified data pertaining to game context, activities, timing of the activities, music style of game music (corresponding to different portions of the video game and based on the game context), etc., is submitted to the AI model 317. In some implementations, the classified data is provided to the deep/machine learning engine 316. In alternate implementations, the game-related, user-related, gameplay-related, and game music-related data obtained from different sources are provided directly to the deep/machine learning engine 316 and an attributes extractor and attributes classifier within the deep/machine learning engine 316 are used to perform the attributes extraction and attributes classification prior to forwarding the classified data to the AI model 317. In alternate implementation, the various data are provided directly to the AI model 317, which is configured to perform the attributes extraction and attributes classification within and use the extracted and classified attributes to identify appropriate portions of the background music for synthesizing. The synthesizing of the game music is done by selecting, modifying, tuning and/or transforming the appropriate portions of the game music or a selected background music so as to match to the music style of the different activities and of the overall music style of the video game.

In some implementations, the AI model 317 is a machine learning model configured to apply machine learning to synthesize the game music/background music for the video game. Alternately, the AI model 317 can employ a deep learning model to apply the deep learning technique to synthesize the game music/background music. In some implementations, the deep/machine learning engine 316 (of FIG. 1) can be configured as a neural network to create and train the AI model 317. The neural network is defined to include a network of interconnected nodes, that receives the game-related, user-related, and game-music related data (collectively referred to as “input data”) as inputs, processes the various inputs iteratively using the different interconnected nodes and generates outputs that match with different output criteria. The output criteria can relate to an activity and identify attributes of an audio clip of the original game music pertaining to the activity so that the attributes can be used to identify an audio clip of the background music that can be used to synthesize the background music that is to be rendered during the activity.

In some implementations, the neural network of the AI model 317 can be a hierarchy of nodes defined by an input layer, an output layer and a plurality of intermediate layers, with the nodes in the input layer connected to the nodes in the plurality of intermediate nodes and the nodes of the intermedia nodes connected to the nodes of the output layer. Beginning with the input layer and ending with the output layer, each node in each subsequent layer learns from the previous layer and vice versa, based on rules defining different outcomes. In some implementations, weights may be assigned to the different attributes and inter-relationships in accordance to rules defined for different output criteria. Each node can include one or more attributes from data obtained from the different sources (game-related data, music-related data, user-related data) and the rules link the attributes in the different layers. Different rules may be defined for different success criteria. In some implementations, the rules may be defined to identify an audio clip that satisfies attributes associated with an activity occurring in the video game. These rules may be defined based on timing when an audio clip identified for an activity needs to be rendered (e.g., presenting the audio clip at the beginning, during, or ending) and an approximate duration for rendering the audio clip, for example. The rules link the various attributes from an input node in the input layer to an output node in the output layer. The AI model 317 can be used to identify an audio clip from within the background music selected by the user for rendering in place of the original game music defined for the video game or from some other background music or, in some cases, from the original game music.

The AI model 317 is configured to use the classified data to determine the game context of the video game, and to use the game context to identify an activity occurring in the video game during a current time. Additionally, the classified data can be used to determine the pace of the gameplay detected in a current portion of the video game. The pace of gameplay can correlate with the pace of the game music that is being rendered during the current gameplay. Toward this end, the AI model 317 analyzes the gameplay data (e.g., game actions) to identify the attributes of the activity, such as game actions performed (i.e., game inputs provided) by the user, rate at which the game actions are performed, from which the pace of gameplay can be determined. The pace of gameplay can be influenced based on the type of activity occurring in the video game, the skill possessed by the user, speed at which the game inputs are provided by the user, etc. In addition to the interactions of the user, actions of other users (in the case of multi-player game), other game characters/game objects may also be considered to determine the pace of the game.

The video game includes a plurality of activities, with each activity defined with corresponding attributes. In some cases, a single activity can be defined to occur in different portions (i.e., different levels, different times) of the game. For example, boss fight can occur any time a boss is present within a game scene. The pace of the game, in some cases, is defined by attributes of the activity and pace of game actions performed during the activity, which are driven by inputs from the user or game character of the user, inputs from other game characters controlled by other users or game objects defined in the game scene. The pace of the actions and the attributes of the activity sets the pace of the original game music rendered for the activity. As the pace of the gameplay varies either based on user-based and/or game character/game objects-based actions (i.e., game inputs), the intensity of the gameplay and, as a result, the pace of the original game music also varies accordingly. The AI model 317 keeps tracks of the gameplay of the user and of other users (in case of multi-player game) by analyzing the various data collected during gameplay, including the game context and the game state and determines the pace of the game music for the portion of the game where the activity is rendering. The pace (i.e., tempo) of the game music rendered for the portion of the video game associated with the activity is synchronized with the pace of the activity occurring in the portion of the gameplay of the video game.

User selection of the video game for gameplay and a background music for rendering with the gameplay are recognized by an Audio Synthesizer engine 315. The user may wish to personalize their gameplay of the video game by selecting an option to switch the game music designed for the video game with a background music of their choice. The background music 330a may be selected from an audio source 330 associated with the user, wherein the audio source 330 can be a list of background music (330-1, 330-2, 330-3 . . . 330-n) maintained by or for the user. The audio source, as noted before, could be a playlist of user-preferred and/or user-generated music, a library of links to music applications, links to website of music composer(s) and/or music distributor(s), etc.

In response to detecting user selection of the video game for gameplay and the background music to render during gameplay, the Audio Synthesizer engine 315 is initiated to determine attributes of the video game, the attributes of an original game music designed for the video game, and attributes of the background music selected for rendering in place of the original game music. The selected background music may lack the music style of the original game music, especially as it relates to activities occurring in the video game. The intensity or tempo of the video game varies with the storyline as well as with the in-game actions (both user-based and character/object-based actions), especially the rate at which the in-game actions are performed. The rate of in-game actions can reflect the emotion of the user, the overall game mood exhibited in the corresponding portion (which can be a result of the in-game actions from the user, other users and game objects/game characters), and also define/drive the intensity of gameplay. The original game music designed for the video game took such variations into consideration and designed the audio track for each portion of the video game to connect with the emotion of the user and correspond with the overall game mood of the video game exhibited in that portion.

In one implementation, the AI model 317 analyzes game logic of the video game, the original game music, and the background music of choice to identify various attributes (game-related, gameplay-related, user-related, music-related), and uses results of the analysis to synthesize the selected background music to mimic the music style defined in the original game music. In some implementations, the synthesis can be done to portions of the selected background music that correspond with activities occurring in the video game during gameplay and can include tuning, transforming, and/or modifying select portions of the background music so that the transformed/tuned/modified portions are rendered in place of the original content of the selected background music during an appropriate time (beginning, during, ending) defined for the activities in the video game.

In particular, the game logic of the video game can be queried to obtain game-related attributes (e.g., type, genre, game sequence/storyline, activities defined, type of game scene designed, game objects, game characters, game rules, game music, and other relevant information). The game-related attributes can be analyzed to understand context of the storyline where each activity is defined to occur, the type of activity scheduled, type of in-game inputs required, type and details of the original game music selected for rendering, etc. The intensity or tempo of gameplay can be defined by the game logic and driven by the in-game actions provided during gameplay including number and type of users/game objects/game characters providing the in-game inputs, etc. The original game music defined for the video game is designed to match the intensity or tempo of the gameplay of the video game.

The attributes of the game music can include the genre, the audio tracks (e.g., vocal track, instrumental track, ambience, sound effects, etc.) included within, and defined by attributes, such as volume, pace, intensity, mood, pitch and rhythm to name a few. Similar attributes can be identified for the background music selected for rendering in place of the original game music.

As the background music selected is not defined in the context of the video game, when the selected background music is rendered in place of the original game music, there will be a disconnect between the music-style of the background music rendering during gameplay and the game-style defining the overall mood of the video game. The overall mood of the video game and, as a result, the emotional connection the user establishes with the video game during gameplay can get adversely affected, especially when the mood in portions of video game where the outcome of the activities resulting from in-game actions does not match the music-style of the background music. Thus, to allow the user to enjoy the background music of their choice and emotionally connect with the gameplay, especially pertaining to the activities, attributes of the activities are identified and portions of the background music that correspond with the activities are modified, tuned, and/or adjusted to include audio clips identified to match with the music style defined for the activities.

In one implementation, the background music is synthesized by executing the audio synthesizer engine 315 prior to the user initiating gameplay of the video game. The audio synthesizer engine 315 is configured to analyze the details of the video game obtained from the game logic to identify relevant game-related information. An attributes extractor 320 of the audio synthesizer engine 315 is used to identify and/or derive gameplay-related attributes 320a and game music-related attributes 320b. In particular, the game-related attributes identified from the game logic include a type, theme, storyline, attributes of activities, game state expected for each activity, in-game actions required to complete the activities, game scenes, game rules, to name a few. Game-related attributes that can be derived include game mood defined for different activities, music-style defined for the different activities, which is driven by game mood, etc. The identified attributes (320a, 320b) are classified by attributes classifier 321 into gameplay-related classifiers 321a and music-related classifiers 321b. The classified attributes are provided as inputs to AI model 317. In some implementations, as noted previously, the attributes extractor 320 and attributes classifier 321 can be integrated into the AI model 317 and used to identify and classify the relevant data associated with the video game prior to processing the relevant data using the AI model 317 to identify the game context and the mood in different portions of the video game and to synchronize the mood of the background music to align with the mood.

The attributes extractor 320 is also configured to analyze the selected background music 330a to identify music-related attributes. The music-related attributes identified for both the background music and the original game music (e.g., genre, theme, volume, pace, intensity, mood, pitch, rhythm, etc.) can be determined to broadly correspond with different audio track elements, such as vocal track, instrumental track, ambience, etc., and the attributes classifier 321 classifies the music-related attributes accordingly. The AI model 317 then uses the attributes of the original game music defining the music style, to identify audio clips that correspond with different activities. The original game music is designed to adjust attributes of each audio clip (i.e., tuned or modified) to account for variances in the game context (e.g., variances in pace of gameplay, variance in in-game actions from different characters/users, etc.).

Specifically, a game context identifier 324 of the AI model 317 is used to analyze the relevant data obtained from game logic to identify attributes of each activity and game context associated with each activity. An activity music style identifier 322 within the AI model 317 is configured to use the attributes of the audio clip associated with each activity in the game context to understand the music-style defined for the activity that is defined in accordance to the mood set for the activity. Where the same activity (e.g., boss encounter) occurs in different portions, the game context, the in-game actions expected and attributes of the audio clip can change and, as a result, the music-style of the game music associated with the audio clip takes such variances into consideration when rendering for the attributes in different portions.

In particular, the AI model 317 uses the attributes of an audio clip of the original game music associated with an activity to identify a corresponding audio clip in the background music. An attributes mapping engine 326 is used to map the attributes of the audio clip of the original game music with corresponding attributes of the background music. It is to be noted that the attributes of the audio clip in the background music identified for the activity might not be an exact match, although it can. Consequently, a predefined matching threshold (e.g., at least 60% or 70%) may be defined for matching the attributes of the audio clip of the background music in order to declare the audio clip of the background music to be a match for the audio clip of the original game music defined for the activity. Where a match is found for the activity, the audio clip of the background music is extracted and tagged with an activity identifier of the activity and an identifier of the audio clip of the original game music. In cases where the activity (e.g., Boss encounter/fight) occurs in different portions of the video game, identifiers of the different portions of the video game can also be included in the tag for the audio clip of the background music. As noted, the attributes of a particular activity can vary based on variations in the game scene, variations in the game pace, variations in the users and/or game characters involved, variations in the in-game actions performed, etc. In these cases, attributes of the identified audio clip of the background music can be modified to account for such variations, so as to fit the mood for the activity. When the activity is encountered during live gameplay of the video game, the tagged audio clip of the background music that is stored for the activity is retrieved and modified in substantial real-time, in accordance to the current game context, and rendered instead of the original portion of the background music.

Where a match is not found for the activity (i.e., the attributes do not match to the predefined matching threshold) within the background music, the audio synthesizer engine 315 may modify certain attributes of the existing portion of the background music to try and match to the mood of the activity. It should be noted that the modification may not substantially or reasonably match the music-style but can be a close enough replication of the music-style.

In alternate implementations, when a match is not found for the activity within the selected background music, the attributes mapping engine 326, through the audio synthesizer engine 315, may query one or more other background music associated with the user to determine if one or more audio clips from any one or more of the other background music is a match. The other background music may be analyzed prior to receiving a request for gameplay of the video game. The other background music can be identified from the audio source associated with the user. In response to detecting a match (i.e., attributes matching to at least a predefined matching threshold), the audio clip of the other background music is extracted, tagged with the details of the activity and the video game and identifier (including location or context identifier) of the original game music, and stored for adjusting the selected background music during live gameplay, when the corresponding activity occurs. When more than one other background music is identified to include audio clips that match to at least the predefined matching threshold, an audio clip with a highest percentage of match of the attributes may be selected. In some alternate implementations, the matching of the attributes of the activity to portions of other background music may be done in real-time during the live gameplay.

To identify the audio clips of the background music, the AI model 317 uses a neural network of nodes defined with the attributes of the original game music and of the background music, the game context and other relevant information of the video game, and the predefined matching threshold, and processes the inputs through the different interconnected layers of the AI model building on inter-relationships to identify outputs in accordance to the rules defined for the different success criteria desired, wherein the success criteria can be user-specific (i.e., type of play engaged or desired by the user (e.g., aggressive, subdued, offensive, etc.)) or activity-specific or combination of both. In some implementations, the neural network may be built and trained for each activity. In other implementations, the neural network may be built for the video game as a whole using the attributes of the selected background music. In some implementations, the neural network is built for the video game using the attributes of a plurality of background music retrieved from an audio source, such as a playlist, associated with the user. The outputs identifying the audio clips for each activity are based on the rules and the attributes of the activity and the neural network is used to identify the outputs for each activity from different background music. More than one match can be identified for each activity within the background music. In such cases, the audio clip with highest attribute match is identified and mapped with information of the activity for subsequent use in adjusting the background music.

When the gameplay of the video game is initiated by the user, an instance of the gameplay of the video game with the selected background music is presented to the user. Simultaneously, the audio synthesizer engine 315 is instantiated to keep track of the progress in the gameplay and current game context of the video game. In one implementation, during gameplay of the video game, the original game music is muted and the selected background music rendered to the user. As noted before, the selected background music can be user-generated or user preferred. As the video game progresses with in-game actions from the user, other users, game objects/game characters, information related to the gameplay of the video game is collected and analyzed in real-time. The game state data collected during live gameplay is used to determine a current game state, current game context, in-game actions performed, actions/activities occurring at current point of time, and use the information to understand the pace and other attributes of gameplay. The game state data is used to generate game content (i.e., game scenes or game environment) corresponding to a current point in time.

In response to an activity occurring in the current point of gameplay, the AI model 317 is automatically triggered to determine the current game context and the activity associated with the current game context, proactively retrieve the audio clip that was mapped to the activity and modify the portion of the original content of the background music that is to be rendered in the video game where the activity is detected, in substantial real-time, so that the audio clip matching the music-style of the activity is rendered instead. One or more attributes of the audio clip may be adjusted to match to the attributes of gameplay (e.g., speed or pace at which the gameplay is being played, the pace at which the in-game actions are being rendered, etc.) so that the audio clip is rendered for the duration defined for the activity.

In some implementations, a morphing engine 318 may be used to transform, in real-time, the portion of the background music so that the audio clip renders seamlessly for the activity. The speed of morphing, in some implementations, is defined based on the attributes of the original content, the content of the audio clip, game context and other attributes of the video game. The adjusted background music rendered for the activity matches to the mood of the activity and has a natural flow.

In some implementations, not all activities occurring in the video game need to have the audio modified/adjusted. The AI model 317 may be configured to identify significant activities (e.g., activities that are difficult to complete or need special skills or require a unique combination of in-game actions, or are needed to progress in the video game or are of importance to the user). The activities can be related to a particular game character or particular level or particular skills, etc. Alternately, the activities for which the audio needs to be modified/adjusted can be defined or identified by the user. In either case, the AI model 317 then can use the attributes of such activities to identify relevant audio clips for rendering during the live gameplay, manipulate the background music to include the relevant audio clips, so as to render the relevant audio clips at appropriate times during the gameplay.

In some implementations, an audio modifier 318-2 is used to adjust the portion of the background music corresponding to the activity by overlaying the audio clip over the portion of the original content identified for the activity. In some implementations, the audio modifier 318-2 may adjust the background music by muting the original audio content in the portion so that the overlaid audio clip can be rendered. The audio clip when identified and mapped for the activity, could have matched the music style of the activity defined in the video game and not dependent on the attributes of gameplay of the video game. However, when the activity occurs during live gameplay, the attributes of the activity may vary due to variation in the in-game actions, intensity of gameplay, game context, etc., which influences the overall mood of the video game. Thus, to ensure the audio clip mapped to the activity matches to the mood of the activity and of the video game in the current game context, one or more attributes of the audio clip may have to be tuned. An audio tuner 318-1 may be employed by the morphing engine 318 to tune the attributes of the audio clip, in real-time, to match with the gameplay attributes in the current game context. In some implementations, the attributes of only a specific audio element (e.g., vocal track, instrumental track, etc.) may be tuned. In alternate implementations, the attributes of the different audio elements may be tuned.

In some implementations, the audio clip may be tuned to render for a duration of time defined for the activity. For example, the audio clip may have been identified to render for a certain length of time determined for a certain type of gameplay (e.g., the skill set of the user, the pace of gameplay, etc.). However, the duration of the activity may vary based on the type of user playing the game, current pace of the video game, etc. For instance, a highly skilled user may complete an activity in a short duration while a novice player might take a longer time to complete the same activity and the identified audio clip for the activity may reflect the duration of time of an average skilled user. Thus, in order to match to the pace of gameplay and/or to the skills of the user, the timing attribute of the audio clip may be tuned so that the audio clip identified for the activity renders for the duration associated with the activity for the user.

In some implementations, as the gameplay is a live gameplay, it may be hard to accurately predict the duration of an activity occurring in the current game context. In such cases, the AI model may analyze the gameplay data of the user collected during current gameplay and/or from one or more prior gameplay sessions of the video game to intelligently predict the duration of the activity, taking into consideration any changes in the skills of the user, the intensity of the video game, etc. Based on the predicted duration, one or more attributes of the audio clip may be dynamically tuned (e.g., the beats of the audio clip may be extended or shortened) so as to allow the audio clip to match to the intensity and render for the predicted duration of the activity. Additional tuning (i.e., continually manipulated) may be done in substantial real-time during the rendering of the audio clip to react to the variations in the gameplay for the activity so that the rendered audio clip synchronizes with the activity.

As noted above, in some implementations, based on the type of activity, the audio clip can be rendered at the beginning, at the end, during, or anywhere between the beginning and ending of the activity, and for a duration defined for the type of activity. For example, for a boss fight, the audio clip may need to be rendered for the duration of the boss fight, which can vary based on the in-game actions of the user, other users, actions from the boss game character and/or other game characters. In another example, the audio clip may need to be rendered at the conclusion of an activity (e.g., after completing a challenging course or level) and for a fixed period of time (e.g., 2 seconds or 5 seconds).

In some implementations, adjusting the background music to render the audio clip for an activity can include pausing the original content of the background music, identifying a resumption point in the background music, rendering the audio clip for the duration defined for the activity, and upon completion of the activity, resuming the background music from the resumption point onward. As noted, depending on the type of activity, the resumption point can be defined to be at a beginning, an end or anywhere between the beginning and end of the activity. In some implementations, the resumption point may be defined based on the status of the activity. The morphing engine 318, in response to detecting the activity, is configured to pause rendering of the original content of the background music, start rendering the audio clip identified and mapped for the activity, and resume the original content after the activity is completed. In some implementations, based on the status of the activity, one or more attributes of the audio clip identified for the activity may be dynamically adjusted to provide a feedback on the status of the user and/or of the activity. In some implementations, the feedback can be configured to convey a level of urgency for the user. For instance, when a user is involved in a boss fight and additional adversaries are entering to feud with the user, then the volume of a portion of the audio clip corresponding to a time when the additional adversaries are entering may be increased. Such adjustment to the audio clip of the background music can be done to generate a sense of excitement for the user. Similarly, when additional support is received by the user during the boss fight, then the attributes of the audio clip in that portion can be dynamically adjusted to render the audio to convey a sense of relief. This type of adjustment can be done based on the game context and, sometimes, can be contrary to the attributes that was originally used to identify the audio clip.

In some implementations, instead of adjusting, tuning or modifying the background music to include appropriate audio clips for select ones of the activities or for every activity occurring in the video game, the original game music may be transformed to generate a new background music. An audio transformer 318-3 may be used to transform the original game music into the new background music by mixing select portions of the original game music and select portions of a background music selected by the user. In some implementations, the base original game music is used and audio clips for the activities are identified from the selected background music by matching the attributes of the original game music associated with the activities of the video game, and replacing portions of the original game music with the selected audio clips for the activities. In some other implementations, the background music may be used as the base background music, and audio clips for the activities are identified from the original game music and used to replace portions of the background music. In these implementations, the audio clips for the different activities are extracted from the original game music, tagged with activity identifiers of the different activities, and the new background music may be generated in substantial real time during the live gameplay of the video game by iteratively modifying the background music as the video game progresses. One or more of the attributes of the audio clips of the original game music may be tuned to fit the pace and intensity of gameplay of the video game. The generated new background music may be stored for the user and used whenever the user selects the video game for gameplay.

The modified background music or the new background music generated for the video game for the user is returned to the client device for rendering during the gameplay. The background music with the modifications or transformations match the music style of the activities and mimic the mood for the video game, allowing the user to emotionally connect and have an enriching gameplay experience.

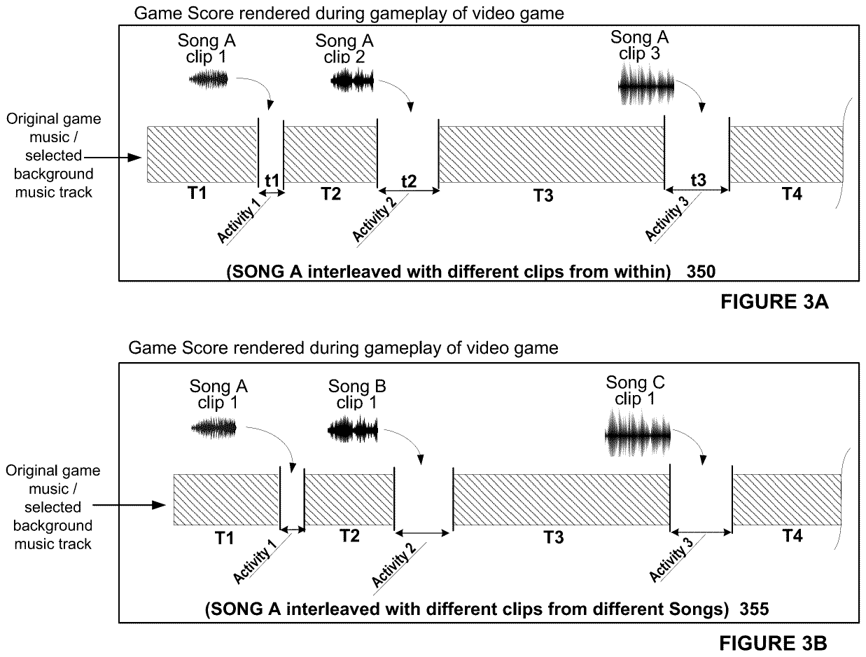

FIGS. 3A and 3B illustrate a game music (also referred to as “game score”) rendered during gameplay of a video game selected for interaction by the user, in some implementations. FIG. 3A illustrates portions of an original game music interleaved with audio clips identified and extracted from a background music (song A). The background music (i.e., song A) can be selected or identified from an audio source associated with the user. In the implementation illustrated in FIG. 3A, an audio clip (clip 1) of song A with attributes substantially matching the attributes of the activity 1 is identified and interleaved by overlaying over a corresponding portion of the original game music associated with activity 1. As noted before, the portion of the original game music associated with activity 1 detected during live gameplay can be at the beginning, at the end, during or anywhere between the beginning and end of activity 1. Duration of clip 1 is tuned to match with the duration (‘t1’) of activity 1 and is interleaved with the original music after time ‘T1’ of gameplay (i.e., at a point defined for the activity 1). The interleaving is done in substantial real-time as the user is playing the game. Similarly, clip 2 of song A identified for activity 2 is interleaved into the original game music after time ‘T2’ of gameplay and corresponds with the time defined for the activity 2. The resulting interleaved game music 350 includes the original game music as the base music with audio clips from song A, which can be a background music selected by the user. Alternately, the background music selected by the user may act as the base music and the audio clips corresponding to the different activities (activities 1, 2, 3, etc.) can be selected from the original game music and interleaved with the background music.

FIG. 3B illustrates an alternate implementation, wherein the original game music or the selected background music is interleaved with audio clips selected from different background music associated with the user in substantial real-time during gameplay of the video game. The different background music can be different from the original game music and the background music selected by the user. The resulting adjusted original game music or background music 355 is represented in FIG. 3B, wherein the audio clip for each activity is identified from a different background music (e.g., clip 1 from song A for activity 1, clip 1 of song B for activity 2, clip 1 of song C for activity 3, etc.). It is not necessary to have the audio clip for each activity to be selected from different background music but has been provided as an example to indicate that the audio clips from different background music can be mixed with the base background music or the base original game music so as to provide a background music that matches the music style for the activities, and the mood and aesthetics of the video game.

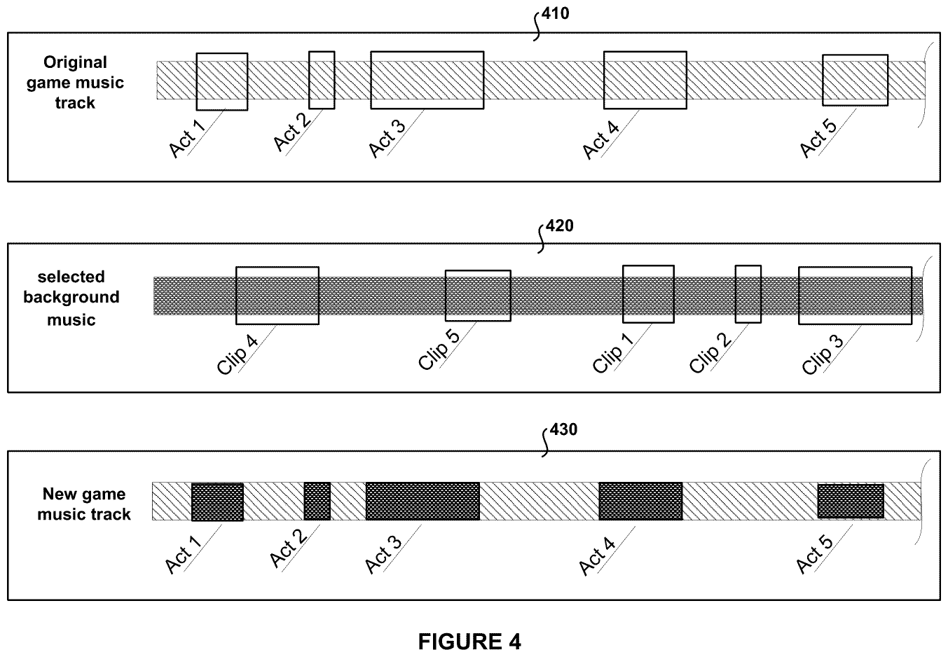

FIG. 4 illustrates an example of a new game music 430 generated by transforming the original game music 410 for the video game. The new game music 430 is generated by mixing portions of the original game music 410 with audio clips identified from a background music 420 selected by the user. The audio clips can be identified from different portions of the background music 420 by matching the attributes of the audio clips for different activities. For instance, attributes of activity 1 may match attributes of clip 1 of the background music 420. Consequently, clip 1 is extracted from the background music and used to modify the portion of the original game music 410 associated with activity 1. Similarly, attributes of activity 2 is identified to correspond with clip 2 of the background music 420 and used to modify the portion of the original game music 410 associated with activity 2, and so on. The resulting new game music 430 generated for the video game includes the audio clips that match the music-style of the original game music.

In essence, the new or modified background music may be dynamically generated using artificial intelligence. In particular, the background music may be dynamically generated or modified based on a game context of the gameplay determined from game data. One or more types of information within the game data may be analyzed by the AI model to determine the game context. For instance, the information may include game state data and game scene data that can be used for activities identification (e.g., all activities, or select ones of activities (defined by the user) or significant activities (defined by game logic or by the user)), important interactions with a gaming environment of the video game, music-style identification for the different activities and for the video game as a whole, and other relevant information. That is, the AI model is trained to identify a plurality of contexts of a plurality of points in any game play of the video game, and is configured to classify and/or identify a context of a game play shown in the video clip. The AI model is executed to determine audio clips that match the music style for the activities (e.g., all, select ones, significant ones) and are appropriate for and/or corresponding with the game context determined based on the progress made in the video game and the activities accomplished/attempted. The AI model can be executed to modify a background music selected by the user or transform the original game music that was defined for the video game based on the determined music-style. Depending on the complexity of the game context and current game state, the music rendered for the video game may include one or more portions of audio clips identified from one or more background music, wherein each audio clip is configured to align with a corresponding activity and be rendered at a time and for a duration of the activity. For example, the music rendered for the video game can include the original game music or a selected background music as the base rendering in general portions of the game and the audio clips selected for each or select ones of the activities rendering in the corresponding portion of the video game. As previously mentioned, the audio clips can be selected from different portions of the selected background music for modifying the background music, or selected from the original game music for modifying the background music, or selected from the background music of choice for modifying the original game music, or selected from different background music for modifying the original game music or the selected background music. The resulting background music (modified or newly generated) may properly reflect the mood of the activity(ies) and the emotions of the user (e.g., serious, relaxed, aggressive, etc.) detected during the gameplay of the video game. The various implementations allow the user to customize the video game to render with the game music of their choice and the audio synthesizer engine 315 synthesizes the user-selected background music to reflect the mood for the different activities, allowing the user to have a personal, impactful and emotional gameplay experience (i.e., a visually satisfying and auditorily compelling experience) with the music of their choice.

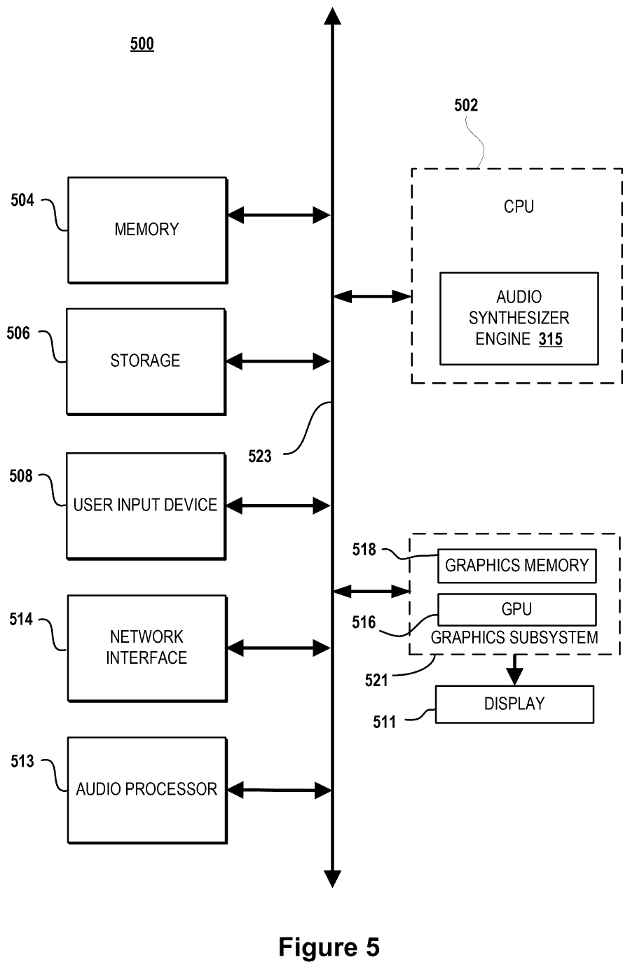

FIG. 5 illustrates components of an example device 500 (e.g., server device within cloud game system 300 of FIG. 1) that can be used to perform aspects of the various embodiments of the present disclosure. This block diagram illustrates a device 500 that can incorporate or can be a personal computer, video game console, personal digital assistant, a server or other digital device, suitable for practicing an embodiment of the disclosure. Device 500 includes a central processing unit (CPU) 502 for running software applications and optionally an operating system. CPU 502 may be comprised of one or more homogeneous or heterogeneous processing cores. For example, CPU 502 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 500 may be a localized to a player playing a game segment (e.g., game console), or remote from the player (e.g., back-end server processor), or one of many servers using virtualization in a game cloud system for remote streaming of gameplay to clients.

Memory 504 stores applications and data for use by the CPU 502. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, tracking devices for recognizing gestures, and/or microphones. Network interface 514 allows device 500 to communicate with other computer systems via an electronic communications network, and may include wired or wireless communication over local area networks and wide area networks such as the internet. An audio processor 513 is adapted to generate analog or digital audio output from instructions and/or data provided by the CPU 502, memory 504, and/or storage 506. The components of device 500, including CPU 502, memory 504, (data) storage 506, user input devices 508, network interface 514, and audio processor 513 are connected via one or more data buses 523.

A graphics subsystem 521 is further connected with data bus 523 and the components of the device 500. The graphics subsystem 521 includes a graphics processing unit (GPU) 516 and graphics memory 518. Graphics memory 518 includes a display memory (e.g., a frame buffer) used for storing pixel data for each pixel of an output image. Graphics memory 518 can be integrated in the same device as GPU 516, connected as a separate device with GPU 516, and/or implemented within memory 504. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In an embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 521 periodically outputs pixel data for an image from graphics memory 518 to be displayed on display device 511. Display device 511 can be any device capable of displaying visual information in response to a signal from the device 500, including CRT, LCD, plasma, and OLED displays. Device 500 can provide the display device 511 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game system via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method, comprising:
analyzing an original game music defined for a video game selected by a user for gameplay, the video game including a plurality of activities and said analyzing used to identify attributes defining a music style corresponding to each activity of the plurality of activities identified in the video game;
analyzing each background music associated with the user to identify an audio clip in said each background music with music attributes that match the music style defined for said each activity of the plurality of activities in the original game music;
detecting selection of the video game for the gameplay by the user and a background music of the user for rendering during the gameplay of the video game, the background music being rendered in an original format in place of the original game music;
detecting an activity of the plurality of activities occurring in the video game during the gameplay; and
responsive to detecting the activity occurring in the video game, dynamically adjusting the original format of a portion of the background music corresponding to the activity, so as to render the audio clip identified to mimic the music style of said activity, the audio clip identified using the attributes of said activity, the background music with the audio clip matching to game context of the video game,
wherein operations of the method are performed by an audio synthesizer engine executing on a processor of a server computing device.

2. The method of claim 1, wherein the audio clip for dynamically adjusting the portion of the background music is identified from within the background music selected for rendering during the gameplay of the video game.

3. The method of claim 1, wherein the audio clip for dynamically adjusting the background music is identified from a second background music associated with the user, and
wherein the second background music is different from the background music selected for rendering during the gameplay.

4. The method of claim 1, wherein adjusting the background music includes morphing content rendering in the original format in the portion of the background music associated with the activity into the audio clip.

5. The method of claim 1, wherein adjusting the background music further includes,
adjusting one or more of the music attributes of the audio clip identified for the activity to correspond with a duration of the activity, the audio clip with the music attributes adjusted rendered for the duration of the activity, and after conclusion of the audio clip, resuming rendering the original format of the background music.

6. The method of claim 1, wherein detecting selection of the video game includes providing an option to switch the original game music of the video game with the background music during gameplay of the video game, said option providing additional options for selecting the background music from a plurality of background music associated with the user.

7. The method of claim 1, said each background music is identified by querying an audio source associated with the user.

8. The method of claim 1, wherein the audio clip identified for the activity is extracted and tagged with identifiers of the activity and context identifiers representing game context of the video game, the audio clip tagged with the identifiers and the context identifiers stored for subsequent retrieval and used for dynamically adjusting the portion of original content of the background music for the activity during live gameplay of the video game.

9. The method of claim 1, further includes,
detecting a second activity occurring in the video game during the gameplay, based on progression made in the video game due to in-game actions provided by the user;
responsive to detecting the second activity in the video game, identifying a second audio clip corresponding to said second activity, the second audio clip is identified by matching the music attributes of the second audio clip with attributes of the second activity defined in the original game music, the second audio clip identified from any one of the background music and a second background music associated with the user; and
dynamically adjusting a corresponding portion of the background music, so as to render the second audio clip for the second activity.

10. The method of claim 1, wherein adjusting the background music further includes,
extracting the audio clip identified for the activity; and
dynamically replacing original content in a first portion of the background music corresponding to the activity with the audio clip extracted for the activity, the dynamic replacement includes,
pausing the rendering of the original content, the pausing identifying a resumption point for restarting the original content;
rendering the audio clip in the first portion instead of the original content; and
resuming the rendering of the original content from the resumption point after conclusion of the activity.

11. The method of claim 10, wherein dynamically replacing the original content further includes morphing the original content in the first portion of the background music with content from the audio clip, and
wherein a speed of morphing is defined based on the attributes of the original content and the content included in the audio clip.

12. The method of claim 1, wherein adjusting the background music further includes tuning one or more of the attributes of the original game music included in the portion so as to match to the music style of the activity.

13. The method of claim 1, wherein the original game music is defined by a game developer as part of the video game.

14. A method, comprising:
analyzing an original game music associated with a video game selected by a user for gameplay, to identify attributes of each activity included therein, the identified attributes define a music style for said each activity;
analyzing a background music selected by the user for rendering during gameplay of the video game, the analyzing used to identify a distinct audio clip of the background music having music attributes that match to the music style defined for said each activity, said distinct audio clip of the background music for said each activity is identified by matching original attributes defining the music style of said each activity in a portion of the original game music with the music attributes of said distinct audio clip of the background music; and
generating a new background music by mixing audio clips identified in the background music with the original game music, such that said distinct audio clip of the background music identified for said each activity replaces a corresponding portion of the original game music, the new background music matches aesthetics of said each activity of the original game music defined for the video game,
wherein operations of the method are performed by an audio synthesizer engine executing on a processor of a server computing device.

15. The method of claim 14, wherein the mixing is done such that when a different activity is detected during the gameplay of the video game, a corresponding distinct audio clip of the background music matching the music style of the different activity is automatically rendered during the gameplay of the video game.

16. The method of claim 14, wherein detecting selection of the video game includes providing an option to switch the original game music of the video game with the background music, the option allowing the user to select one of the background music associated with the user for rendering during the gameplay of the video game.

17. The method of claim 14, wherein generating the new background music further includes,
synthesizing, using an audio synthesizer, the original game music defined for the video game so as to include the distinct audio clip corresponding to each activity in appropriate portions of the original game music, such that the background music is synthesized to match to the music style of said each activity and to game context of the video game determined from game state data generated during gameplay, the new background music generated matches aesthetics and mood of the video game and mimics music style of said each activity.

18. The method of claim 14, wherein generating the new background music includes dynamically tuning one or more attributes in the distinct audio clip of the background music associated with an activity to substantially mimic the attributes of the original game music corresponding to said activity, the distinct audio clip of the background music with the tuned one or more attributes replacing a portion of the original game music corresponding to said activity when generating the new background music.

19. The method of claim 14, wherein the distinct audio clip is identified from a second background music, wherein audio content of the distinct audio clip of the second background music substantially mimicking the music style of said each activity defined in the original game music of the video game.

20. A method, comprising:
analyzing gameplay data of a video game played by a user to identify an activity and attributes of said activity occurring during gameplay of the video game, the attributes defining a music style of said activity, said gameplay data generated during the gameplay analyzed in substantial real-time to determine current game context, the gameplay of the video game rendering using original game music;
identifying a resumption point associated with the activity;
identifying an audio clip from a background music with music attributes that match with the music style of said activity; and
dynamically transitioning a portion of the original game music starting at the resumption point to render audio content of the audio clip, and upon completing rendering of the audio clip, resuming the rendering of the original game music from the resumption point,
wherein operations of the method are performed by an audio synthesizer engine executing on a processor of a server computing device.

21. The method of claim 20, wherein the background music is selected by the user or identified by the audio synthesizer engine based on preferences of the user, said preferences obtained from a user profile of the user or determined from music selection at an interactive application providing access to the background music.

22. The method of claim 20, wherein the resumption point is defined based on a type of activity, game context of the video game, and a status of the activity.

23. The method of claim 20, wherein the resumption point is defined at a beginning, an end, or any point between the beginning and the end of said activity.

24. The method of claim 23, wherein the resumption point is defined based on a status of the activity.

25. The method of claim 20, transitioning the portion of the original game music further including morphing original content of the original game music with content from the audio clip identified from the background music so as to provide a natural transition from the original content to the content of the audio clip, wherein a speed of morphing depending on a game context of the gameplay and in-game actions provided by the user during gameplay.

26. The method of claim 20, further includes, identifying a second activity occurring during the gameplay of the video game, wherein said second activity has a distinct music style that is different from the music style of the activity,
wherein identifying a second audio clip with the music attributes that match with corresponding distinct music style of said second activity, the second audio clip of the background music identified for the second activity rendered in place of a corresponding portion of the original game music starting at a resumption point identified for said second activity.

27. The method of claim 26, wherein said second audio clip corresponding to the second activity identified from the background music.

28. The method of claim 26, wherein said second audio clip corresponding to the second activity identified from a second background music associated with the user, the second background music retrieved from an audio source associated with the user and is different from the background music and the original game music.
